(19) United States
(12) Patent Application Publication
(10) Pub. No.: US 2002/0071013 A1
(43) Pub. Date: Jun. 13, 2002

(54) Pressure-compensation device for ink reservoirs

(75) Inventors: Te-Jung Hsu, Putz City (TW); Ming-Chung Peng, Hsinchu (TW)

Correspondence Address: DOUGHERTY & TROXELL, SUITE 1404, 5205 LEESBURG PIKE, FALLS CHURCH, VA, 22041, US

(73) Assignee: Acer Communications & Multimedia Inc.

(21) Appl. No.: 10/001,822

(22) Filed: Dec. 5, 2001

(30) Foreign Application Priority Data
Dec. 11, 2000 (TW) 89126377

(51) Int. Cl. B41J 2/175

(52) U.S. Cl. 347/86; 347/87

(57) ABSTRACT

A pressure-compensation device for ink reservoirs includes an accumulator bag, a resilient element and an air-compensation means. The accumulator bag is installed inside the ink reservoir and provides a duct for air communicating with the atmosphere. While the ink inside the ink reservoir is running off, external air can be led automatically through the duct to inflate the accumulator bag. The resilient element has a lower end to engage with a bottom end of the accumulator bag for stabilizing a back pressure inside the ink reservoir by acting contraction against the inflating of the accumulator bag. While the accumulator bag is expanded to a saturated state, the air-compensation means can introduce automatically external air into the ink reservoir for maintaining the back pressure and thus for avoiding any ink leakage and stalling of the print head.

### BACKGROUND OF THE INVENTION

(1) Field of the Invention

The invention relates to a pressure-compensation device for ink reservoirs, and more particularly to an interior device which can stabilize an internal back pressure of the ink reservoir to prevent the ink reservoir from ink leakage and to supply ink drops to an ink-jet printer stably.

(2) Description of the Prior Art

In the computer industry, an ink-jet printer is one of well-known computer peripheral devices which performs print jobs coordinated by the computer by providing ink drops from an ink reservoir, through a print head, onto an empty paper or other recording media.

In the art, a well-designed ink reservoir for providing good ink drops needs to satisfy the following two requirements.

1. While the ink reservoir is at an idle state, an internal pressure Pi of ink reservoir is required to be lower than the external atmosphere pressure Po for preventing the ink reservoir from ink leakage.

2. While the ink reservoir is at a printing state, an additional pressure needs to be supplied to the ink reservoir for increasing the internal pressure Pi to be greater than the external atmosphere pressure Po so that the ink inside the ink reservoir can be dropped out through the print head.

To satisfy the aforesaid first requirement, a resort in the art is to add a back pressure Pb into the ink reservoir. By providing the back pressure Pb, the internal pressure Pi of ink reservoir during the idle state can be maintained at a pressure level lower than the external atmosphere pressure Po for avoiding any possible ink leakage from the print head. On the other hand, to satisfy the aforesaid second requirement, a resolution in the art is to apply a specific print head of thermal bubble type or piezoelectric pressure wave type. By applying any aforesaid specific type of print head, a proper print pressure P can be generated inside the ink reservoir during a print job. While the print pressure P is greater than the back pressure Pb, the internal pressure Pi can reach a pressure level higher than the atmosphere pressure Po, so that the ink reservoir can provide ink drops through the print head to perform the print job. Yet, the art of the print head is not within the scope of the present invention; therefore, no more efforts thereofabout will be provided in the following discussion.

It is understood that the atmosphere pressure Po varies along with the ambient. For example, the atmosphere pressure Po in a flying airplane or at a location of higher elevation is always lower than the atmosphere pressure on the ground, and so it is quite possible in some particular locations that the internal pressure Pi of ink reservoir is greater than the atmosphere pressure Po. As a matter of fact, under the aforesaid situation, the ink dropping out from the ink reservoir will occur even no print job is at work.

In addition, the back pressure Pb inside the ink reservoir increases with the consumption of the ink. Therefore, while meeting a situation of the back pressure Pb greater than the print pressure P of print head, the ink reservoir then needs to be replaced anyway, even there is still some ink left in the ink reservoir.

To resolve the aforesaid disadvantages of the ink reservoir, a pressure-sensitive accumulator for ink-jet pens disclosed in a U.S. Pat. No. 5,409,134 introduces a device to adjust the back pressure Pb inside the ink reservoir for maintaining the internal pressure Pi to be less than the atmosphere pressure Pi; so that the aforesaid ink leakage problem and the aforesaid redundant ink problem can be resolved successfully. The technique provided by the US patent is briefed as follows.

Referring now to FIG. 1A and FIG. 1B, two states of a traditional ink reservoir 1 including the pressure-sensitive accumulator 10 of U.S. Pat. No. 5,409,134 are shown, respectively. The pressure-sensitive accumulator 10 includes a spring 12 and an accumulator bag 14. The spring 12 further includes a fitment 121 for anchoring the spring 12 to a top portion of the ink reservoir 1, and two spring legs 122 positioned at opposing ends of the fitment 121. The accumulator bag 14, formed as an inflatable bag structure, further includes an air duct 143, a first side 141 and an opposing second side 142. As shown, the first side 141 and the second side 142 are connected at both ends to form the bag structure and have the duct as a ventilation means to the atmosphere.

While in producing the ink reservoir 1, a little interior space other than the room for filling the ink is left to allow the exterior air to flow into the accumulator bag 14 through the duct 143. While the air expanding the accumulator bag 14 inside the ink reservoir 1, the spring legs 122 of the spring 12 can be bent to a shape as shown in FIG. 1B. The resilience provided by the deformed spring legs 122 can then restrain the expansion of the accumulator bag 14 and thus induce a back pressure Pb to the interior of the ink reservoir 1. The induced back pressure Pb can then contribute to the internal pressure Pi to be less than the external atmosphere pressure Po. Due to the duct 143 connecting the atmosphere with the interior of the accumulator bag 14, the internal pressure Pi of the ink reservoir 1 can be always kept to be less than the external atmosphere pressure Po so that no ink leakage problem can occur, even that the ink reservoir 1 is brought to a higher elevation place or a flying airplane.

In the aforesaid reservoir 1 structure, after a substantial time of usage, the ink inside the ink reservoir 1 will run off gradually and the accumulator bag 14 of the pressure-sensitive accumulator 10 will be thus inflated as a state shown in FIG. 1B. Also, the spring legs 122 is further deformed to produce more back pressure Pb to the interior of the ink reservoir 1 for preventing a possible ink leakage problem.

Nevertheless, the aforesaid pressure-sensitive accumulator 10 does exist some practical disadvantages. One of these disadvantages comes from the spring leg 122. It is aware that the back pressure Pb is increased with the deforming of the spring legs 122. As long as the back pressure Pb inside the ink reservoir 1 is greater than the print pressure provided by the print head (not shown in figures) upon a print request, the printing job may then be processed without an ink supply from the ink reservoir 1, even though some ink does be still left in the ink reservoir 1. It is clear that this disadvantage will lead to a short lifetime of the ink reservoir 1 and a cost hike for using such kind of the ink reservoir 1. Another disadvantage for using the aforesaid pressure-sensitive accumulator 10 is its structural complication thereof and a consequent installation problem. Moreover, the pressure-sensitive accumulator 10 occupies a substantial amount of interior volume of the ink reservoir so that the room for storing the ink can be further lessened.

### SUMMARY OF THE INVENTION

Accordingly, it is a primary object of the present invention to provide a pressure-compensation device for ink reservoirs which can adjust the back pressure inside the ink reservoir to a proper range for ensuring normal operation of the print head and preventing possible ink leakage.

It is another object of the present invention to provide a pressure-compensation device for ink reservoirs which can stabilize the back pressure inside the ink reservoir so as to smoothen the print operation till run-out of the ink inside the ink reservoir.

It is a further object of the present invention to provide a pressure-compensation device for ink reservoirs which can be simply constructed so as to reduce design cost.

It is one more object of the present invention to provide a pressure-compensation device for ink reservoirs which can not occupy substantially the interior space of the ink reservoir so as to have the ink reservoir contain more ink and thus increase the service time of the ink reservoir.

The pressure-compensation device for ink reservoirs in accordance with the present invention is designed to be used in ink-jet printer. The ink reservoir is a sealed container for providing an internal space to accommodate a substantial amount of ink. The pressure-compensation device includes an accumulator bag, a resilient element and an air-compensation means.

The accumulator bag is installed inside the ink reservoir and further includes a bottom end and a top-end duct for air communicating an interior thereof with the atmosphere. The ink inside the ink reservoir is stored under the bottom of the accumulator bag. While the ink of the ink reservoir is gradually run off, external air can be led into the interior of the accumulator bag through the duct to inflate and thus extend downward the accumulator bag. The resilient element includes a lower end for engaging with the bottom end of the accumulator bag and is always kept at a tension state. The contraction provided by the elongated resilient element can act against the inflating of the accumulator bag so as to induce a proper back pressure inside the ink reservoir. As long as the accumulator bag is inflated to a saturated state, the air-compensation means can introduce a substantial amount of external air into the ink reservoir for stabilizing the back pressure.

In accordance with the present invention, the air-compensation means for automatically feeding air into the ink reservoir so as to maintain the back pressure at a predetermined stable level upon the accumulator bag being inflated to a saturated state further includes an air-compensation chamber, a preloaded compression spring and a ball. The air-compensation chamber can be constructed at a proper location of the ink reservoir; for example, at a lateral side or at a bottom side. The air-compensation chamber can further have a first opening for communicating the chamber with the atmosphere and a second opening for communicating the chamber with the internal space of the ink reservoir. The compression spring provides one end to engage with the ball and another end to engage with an inner wall of the air-compensation chamber. The ball is depressed to seal the first opening by the compression spring for preventing the ink inside the ink reservoir from leaking through the air-compensation means. After the accumulator bag is inflated to the saturated state, the back pressure inside the ink reservoir will keep rising. As the back pressure overcomes the forcing that the compression spring acts upon the ball, the ball can be separated from the first opening by the atmosphere pressure and allow the external air to flow into the ink reservoir through the first opening and the second opening. The introducing of the external air can not be stopped until the back pressure inside the ink reservoir returns to a steady state. At this time, the expansion provided by the compression spring can then depress the ball back to seal the first opening.

By providing a stable back pressure inside the ink reservoir according to the present invention, the problem of ink leakage can thus be avoided. Also, the ink inside the ink reservoir can be utilized all the way to the run-out without stalling the operation of the print head. Further, due to a small occupation of the pressure-compensation device inside the ink reservoir, major internal space of the ink reservoir can be used to store the ink and thus service lifetime of the ink reservoir can be increased.

All these objects are achieved by the pressure-compensation device for ink reservoirs described below.

### BRIEF DESCRIPTION OF THE DRAWINGS

The present invention will now be specified with reference to its preferred embodiment illustrated in the drawings, in which

FIG. 1A is a schematic cross-sectional view showing a prior pressure-sensitive accumulator inside an ink reservoir at an un-inflation state;

FIG. 1B is a schematic cross-sectional view of the prior pressure-sensitive accumulator of FIG. 1A at an inflation state;

FIG. 2A is a schematic cross-sectional view of a first embodiment of the pressure-compensation device for ink reservoirs in accordance with the present invention at an un-inflation state;

FIG. 2B is a schematic cross-sectional view of the first embodiment of FIG. 2A at an inflation state;

FIG. 3 is a schematic cross-sectional view of the first embodiment of FIG. 2A showing a preferred air-compensation means of the present invention at work;

FIG. 4 is a schematic cross-sectional view of a second embodiment of the pressure-compensation device for ink reservoirs in accordance with the present invention; and

FIG. 5 is a schematic cross-sectional view of a third embodiment of the pressure-compensation device for ink reservoirs in accordance with the present invention.

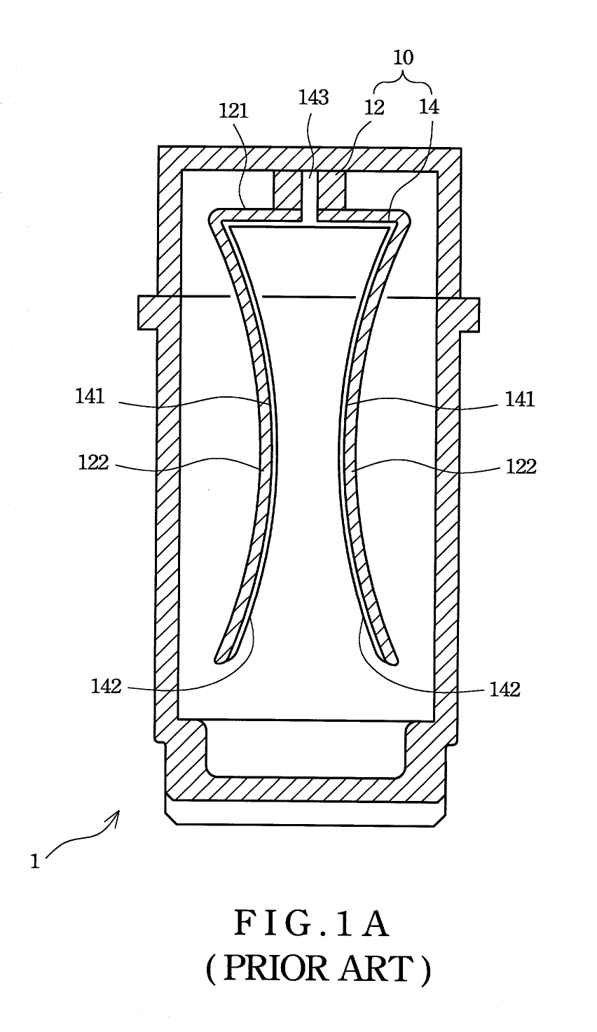

### DESCRIPTION OF THE PREFERRED EMBODIMENT

The invention disclosed herein is directed to a pressure-compensation device for ink reservoirs. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

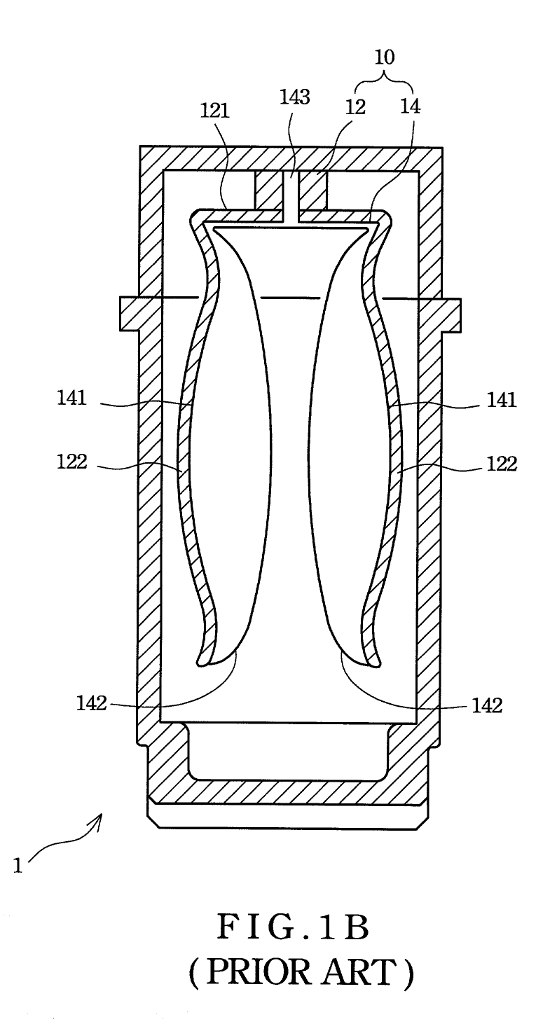

Referring now to FIG. 2A and FIG. 2B, two states of a first embodiment of the pressure-compensation device for ink reservoirs in accordance with the present invention are shown, respectively. The ink reservoir 2 is a sealed container for providing an internal space to accommodate a substantial amount of ink 20. The pressure-compensation device includes an accumulator bag 21, a resilient element 23 and an air-compensation means 24.

The accumulator bag 21 as shown is installed inside the ink reservoir 2 and further includes a bottom end 213 and a top-end duct 211 for air communication between the inner space of the accumulator bag 21 and the atmosphere. The ink 20 inside the ink reservoir 2 is stored in the close space 100 under the bottom of the accumulator bag 21. While the ink 20 of the ink reservoir 2 is gradually running off, external air can be led automatically into the interior of the accumulator bag 21 through the duct 211 so as to inflate and thus extend downward the accumulator bag 21. As shown, the bottom end 213 of the accumulator bag 21 can be connected with a disc 212. Thereby, the disc 212 can move up and down along with the inflation of the accumulator bag 21.

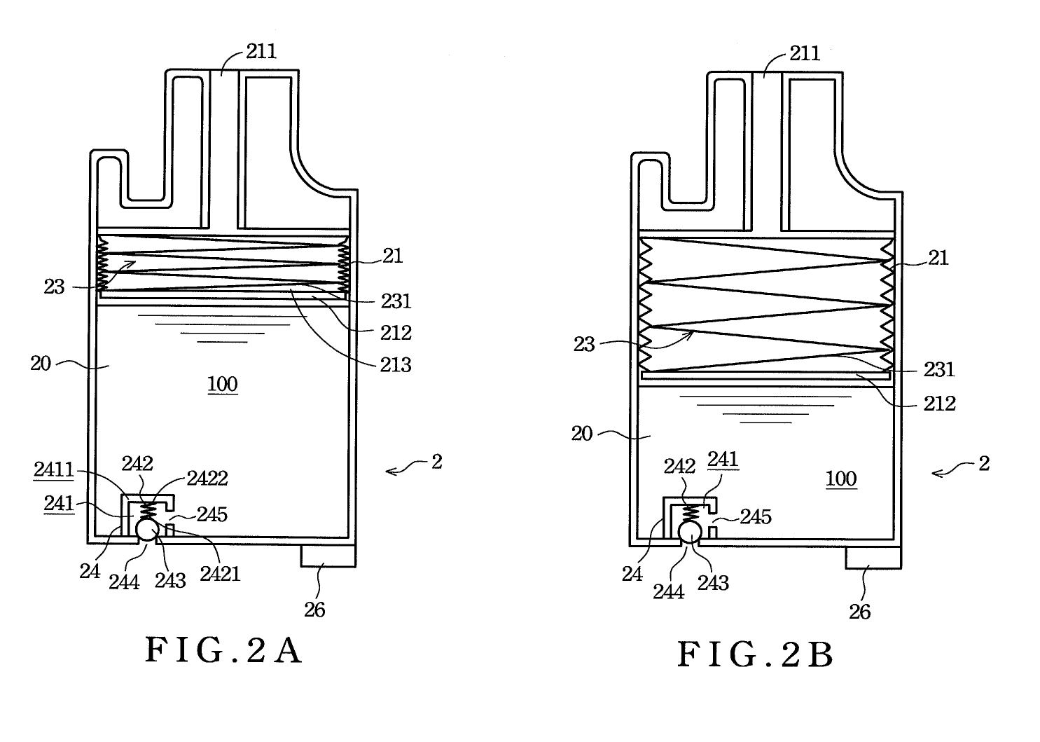

The resilient element 23 as shown can be installed inside the accumulator bag 21 of the ink reservoir 2, and further includes a lower end 231 for engaging with the disc 212 at the bottom end of the accumulator bag 21 and is always kept at a tension state. The contraction force provided by the elongated resilient element 23 can act against the inflating of the accumulator bag 21 so as to induce a proper back pressure Pb inside the ink reservoir 2. As the ink 20 of the ink reservoir 2 is running off, the accumulator bag 21 will inflate gradually and finally reach a saturated state that the accumulator bag 21 can't be inflated further. As long as the accumulator bag 21 is inflated to the saturated state, the back pressure Pb inside the ink reservoir 2 can rise gradually with the consumption of the ink 20. To avoid an over-range back pressure Pb to stall the print head 26 for jetting the ink 20, the air-compensation means 24 of the present invention can then introduce a substantial amount of external air into the ink reservoir 2 for stabilizing the back pressure Pb inside the ink reservoir 2, as shown in FIG. 3.

In accordance with the present invention, the air-compensation means 24 for automatically feeding external air into the ink reservoir 2 to maintain the back pressure Pb within a predetermined acceptable range while the accumulator bag 21 being inflated to the saturated state can further include an air-compensation chamber 241, a preloaded compression spring 242 and a ball 243. The air-compensation chamber 241 can be constructed at a proper location of the ink reservoir 2; say either at a lateral side or at a bottom side as shown. The air-compensation chamber 241 can further have a first opening 244 for communicating the chamber 241 with the atmosphere and a second opening 245 for communicating the chamber 241 with the internal space 100 of the ink reservoir 2. The compression spring 242 provides one end 2421 to engage with the ball 243 and another end 2422 to engage with an inner wall 2411 of the air-compensation chamber 241, as shown in FIG. 2A. The ball 243 is depressed to seal the first opening 244 by the preloaded compression spring 242 for preventing the ink 20 inside the ink reservoir 2 from leaking through the air-compensation means 24. After the accumulator bag 21 is inflated to the saturated state, the back pressure Pb inside the ink reservoir 2 will keep rising. As the back pressure Pb overcomes the forcing that the compression spring 242 acts upon the ball 243, the ball 243 can be pushed to separate from the first opening 244 by the atmosphere pressure and thus allow the external air to flow into the ink reservoir 2 through the first opening 244 and the second opening 245 as shown in FIG. 3. The introducing of the external air cannot be stopped until the back pressure Pb inside the ink reservoir 2 returns to a steady state. At this time, the expansion provided by the compression spring 242 can depress the ball 243 back to seal the first opening 244 as shown in FIG. 2A.

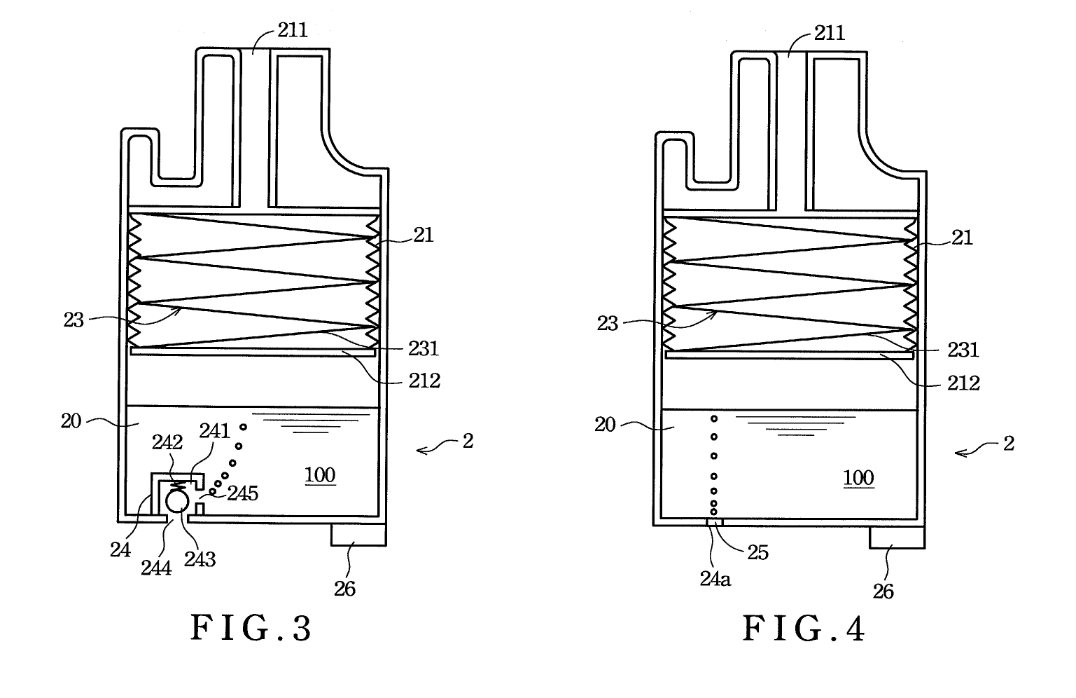

Referring now to FIG. 4, a second embodiment of the pressure-compensation device for ink reservoirs is shown schematically. In this embodiment, except for the air-compensation means 24a, all other components are the same as those used in the first embodiment shown in FIGS. 2A, 2B and 3. As shown in FIG. 4, the air-compensation means 24a of the second embodiment is embodied as a penetration hole having a hydrophobic insert 25. By providing the hydrophobic insert 25, the ink 20 inside the ink reservoir 2 can be waived from a leakage through the insert 25, but on the other hand the external air can be allowed to permeate through the insert as the back pressure Pb rises to a level that an air compensation through the air-compensation means 24a is required.

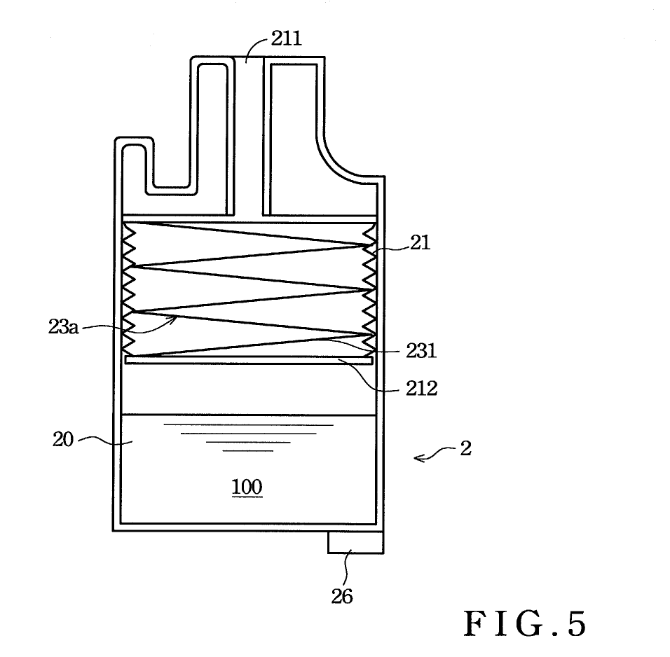

Referring now to FIG. 5, a third embodiment of the pressure-compensation device for ink reservoirs is shown schematically. In this embodiment, the resilient element 23a has a varying elastic modulus which is introduced to provide a constant contraction no matter what the inflation of the accumulator bag 21 is. That is to say, the elastic modulus of the resilient element 23a can decrease schematically as the elongation of resilient element 23a is increased, i.e. as the inflation of the accumulator bag 21 is extended. It is obvious in this embodiment that the accumulator bag 21 during inflating can endure less contraction from the resilient element 23a than those in aforesaid embodiments, so that the back pressure Pb may be kept almost at a constant during the consumption of the ink 20. By such an arrangement, this embodiment can stabilize the back pressure Pb in the ink reservoir 2 without the air-compensation means 24 for automatically feeding the external air into the ink reservoir 2 as described above in those previous embodiments.

Definitely, according to the present invention, the resilient element 23 can be a linear tension spring or any elastic element in the art which can act as the described resilient element 23.

As described above, the pressure-compensation device for ink reservoirs in accordance with the present invention has at least following advantages.

a. The back pressure inside the ink reservoir can be maintained within an acceptable range for ensuring no occurrence of the ink-leakage even upon meeting an atmosphere pressure change.

b. Due to stabilization of the back pressure, the ink inside the ink reservoir can be used all the way to run-out without stalling the operation of the print head.

c. By providing the simple structure, cost for design and assembly can be reduced to a minimum.

d. For requiring only a limited space inside the ink reservoir for installing the pressure-compensation device, major internal space of the ink reservoir can be used to store the ink and thus service lifetime of the ink reservoir can be increased.

While the present invention has been particularly shown and described with reference to a preferred embodiment, it will be understood by those skilled in the art that various changes in form and detail may be without departing from the spirit and scope of the present invention.

I claim:

1. A pressure-compensation device for ink reservoirs, the ink reservoir being a sealed container for providing an internal space to accommodate a substantial amount of ink, comprising:
an accumulator bag, installed inside the ink reservoir, further including a bottom end and a top-end duct for air communicating an interior thereof with the atmosphere, external air led into the interior through the duct to inflate the accumulator bag as the ink running off; and
a resilient element for stabilizing a back pressure inside the ink reservoir by acting against inflating of the accumulator bag, further including a lower end thereof to engage with the bottom end of the accumulator bag.

2. The pressure-compensation device for ink reservoirs according to claim 1 further includes an air-compensation means located in said internal space for automatically feeding air into said ink reservoir so as to maintain said back pressure at a predetermined level while said accumulator bag being inflated to a saturated state.

3. The pressure-compensation device for ink reservoirs according to claim 1, wherein said resilient element is preloaded to a tension state for providing a contraction to act against said inflating of said accumulator bag.

4. The pressure-compensation device for ink reservoirs according to claim 1, wherein said resilient element is a tension spring.

5. The pressure-compensation device for ink reservoirs according to claim 1, wherein said resilient element is located inside said accumulator bag.

6. The pressure-compensation device for ink reservoirs according to claim 4, wherein said accumulator bag further includes a disc located at said bottom end and engaged with said tension spring.

7. The pressure-compensation device for ink reservoirs according to claim 1, wherein said air-compensation means further includes thereof an air-compensation chamber, a compression spring and a ball; the air-compensation chamber having thereof a first opening for communicating therebetween with the atmosphere and a second opening for communicating therebetween with said internal space; the compression spring having thereof one end engaged with the ball and another end engaged with an inner wall of the air-compensation chamber; upon said back pressure less than a spring pressure provided by the compression spring, the compression spring forcing the ball to seal the first opening for preventing said ink leaving said internal space; and upon said back pressure greater than the spring pressure, the ball leaving the first opening for allowing said air entering said internal space through the first opening and the second opening.

8. The pressure-compensation device for ink reservoirs according to claim 7, wherein said air-compensation means is located at one lateral side of said ink reservoir.

9. The pressure-compensation device for ink reservoirs according to claim 7, wherein said air-compensation means is located at a bottom side of said ink reservoir.

10. The pressure-compensation device for ink reservoirs according to claim 7, wherein said air-compensation means is a penetration hole having a hydrophobic insert for allowing said air to permeate therethrough without dripping of said ink.

11. The pressure-compensation device for ink reservoirs according to claim 1, wherein said resilient element has a varying elastic modulus which provides a constant contraction during said inflating of said accumulator bag.

12. An air-compensation means for regulating an internal pressure of an ink reservoir, comprising an air-compensation chamber, a preloaded compression spring and a ball; the air-compensation chamber having thereof an opening for communicating therebetween with the atmosphere; the compression spring having thereof one end engaged with an inner wall of the air-compensation chamber and another end engaged with the ball to make the ball sealing the opening; upon an external pressure outside the ink reservoir greater than a combination of a spring pressure provided by the compression spring and the internal pressure, the ball separating from the opening to allow external air to flow into the ink reservoir for adjusting the internal pressure.
